(19) United States
(12) Patent Application Publication
(10) Pub. No.: US 2011/0302925 A1
(43) Pub. Date: Dec. 15, 2011

(54) Method and Apparatus for Controlling the Operation of a Gas Turbine

(75) Inventor: David William Artt, Lisburn (GB)

(73) Assignee: Vykson Limited, Lisburn (GB)

(21) Appl. No.: 12/815,119

(22) Filed: Jun. 14, 2010

(51) Int. Cl. F02C 1/00; F02C 3/20

(52) U.S. Cl. 60/772; 60/39.461

(57) ABSTRACT

An apparatus for controlling the operation of a gas turbine engine to enable the engine to utilize low calorific value gas, such as low quality landfill gas, said apparatus comprising a gas compressor for compressing gas to be combusted in the combustion chamber of the engine, means for supplying a low calorific value gas to an input of said compressor, and means for mixing a non-combustible gas, such as air, with said low calorific-value gas supplied to the compressor to control the power output of the engine while maintaining a substantially constant flow rate of gas through the compressor.

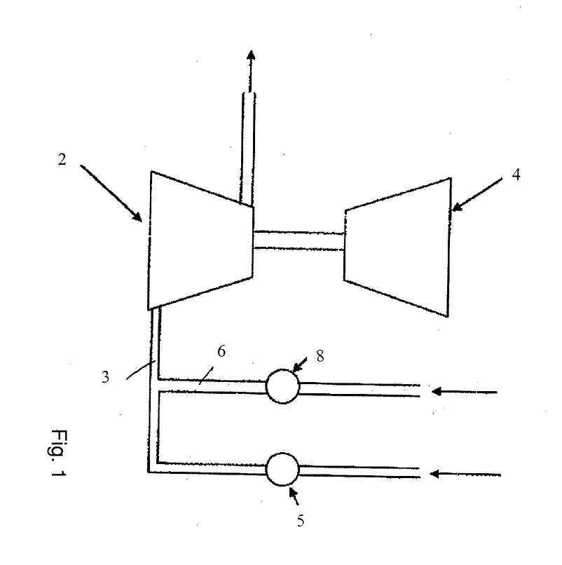

### BACKGROUND

This disclosure relates to method and apparatus for controlling the operation of a gas turbine engine and in particular to a method and apparatus for controlling the operation of a gas turbine engine to enable the gas turbine engine to utilize low quality landfill gases.

Landfill sites produce methane gas due to anaerobic digestion of waste material contained therein. Such gas is highly explosive and must therefore be extracted from the landfill. In some cases, this can be done passively, simply by placing open pipes in the landfill through which the methane can vent. However, methane is a greenhouse gas and therefore, for environmental reasons, it is desirable to dispose of the methane without releasing it into the atmosphere. Since methane is a flammable gas, it is desirable to extract useful energy from the gas by burning it in an engine.

When gas is initially extracted from landfill sites, the methane content of the gas is relatively high, up to 60% methane by volume (the remainder comprising inert gases, mostly carbon dioxide). Such gas can be readily burnt in a reciprocating internal combustion engine, generating useful energy. However, over time the proportion of methane in the gas reduces until, below 30% methane by volume, the gas can no longer be used to fuel an internal combustion engine. Typically, the gas is then simply flared off. Once below approximately 22% methane by volume, the gas will no longer burn in a flare and must then be simply vented to atmosphere.

### BRIEF SUMMARY

An object of the present disclosure is to provide a means of combusting and extracting useful energy from landfill gas having a methane content as little as 10% by volume by combustion of the gas in a gas turbine engine.

When gaseous fuels are burnt in a gas turbine engine, the gas must first be compressed to a pressure above the engine cycle pressure to enable the gas to be injected into the engine combustion chamber. When low calorific value gases are used, such as low quality landfill gas, the volume of gas required to supply the required flow rate of fuel becomes very high, requiring even greater compression of the gas, typically beyond that achievable by a reciprocating piston compressor.

Because of the high volume of gas a turbo-compressor is more suitable than a conventional reciprocating compressor. A turbo-compressor can provide the required degree of compression. However, turbo-compressors are considered unsuitable for compressing combustible gas supplied to a gas turbine because they require a substantially constant flow rate to avoid surging or stalling and operate with greatest efficiency over only a narrow range of gas flow. These requirements contradict the need to throttle or otherwise control the amount of combustible gas supplied to the combustion chamber in order to control the power output of the engine.

Problems are also encountered when attempting to combust landfill gas in a gas turbine engine due to fluctuations in the methane content of the landfill gas, which can cause unexpected fluctuations in the available combustible gas and thus the power output of the engine leading to possible damage to the turbine and/or compressor of the gas turbine.

According to a first aspect of the present disclosure, there is provided an apparatus for controlling the operation of a gas turbine engine to enable the engine to utilize low calorific value gas, such as low quality landfill gas, said apparatus comprising a gas compressor for compressing gas to be combusted in the combustion chamber of the engine, means for supplying a low calorific value gas to an input of said compressor, and means for mixing a non-combustible gas, such as air, with said low calorific-value gas supplied to the compressor to control the power output of the engine while maintaining a substantially constant flow rate of gas through the compressor.

Preferably said gas compressor comprises a turbo-compressor.

The apparatus may include control means for controlling the amount of non-combustible gas mixed with the low calorific value gas as a function of a desired power output of the engine. Alternatively, or additionally, said control means may be arranged to control the amount of non-combustible gas mixed with the low calorific value gas as a function of a measured power output or speed of the engine in order to eliminate fluctuations in the power output of the engine caused by fluctuations in the calorific value of the low calorific value gas.

The apparatus may include means for controlling the flow rate of low calorific value gas in proportion of the flow rate of the non-combustible gas to maintain a constant total flow rate of the mixture of low calorific value gas and non-combustible gas supplied to the compressor.

Preferably, the flow rate of non-combustible gas mixed with the low calorific value gas is controlled by a first valve. Preferably, the non-combustible gas is supplied from a pressurized source, such as a pressurized reservoir or from a pump or a fan or other source of pressurized air.

Preferably, a second valve is provided for controlling the flow of low calorific gas supplied to the compressor.

Preferably, the compressor is operably connected to a turbine for driving the compressor. In one embodiment, said turbine may be arranged to be driven by the hot gases exiting the combustion chamber of the gas turbine engine. Alternatively, said compressor may be operable connected to the output shaft of the gas turbine engine.

According to a further aspect of the present disclosure, there is provided a method of controlling the operation of a gas turbine engine to enable the engine to utilize low calorific value gas, such as low quality landfill gas, said gas turbine engine comprising a compressor for compressing gas to be supplied to the combustion chamber of the engine, said method comprising mixing a non-combustible gas, such as air, with said low calorific-value gas supplied to the compressor to control the power output of the engine while maintaining a substantially constant flow rate of gas through the compressor.

According to a further aspect of the present disclosure, there is provided a method of operating a gas turbine engine comprising providing a compressor for supplying high pressure gas to the combustion chamber of the gas turbine engine, supplying a mixture of a low calorific value gas and a non-combustible gas to the compressor and adjusting the proportion of non-combustible gas in said mixture to control the power output of the gas turbine engine. Preferably, the compressor is a turbo-compressor.

### BRIEF DESCRIPTION OF THE DRAWING

An embodiment of the present disclosure will now be described, by way of example, with reference to the accompanying drawing, comprising a schematic representation of an apparatus for controlling the operation of a gas turbine engine.

### DETAILED DESCRIPTION

As shown in the drawing, the apparatus comprises a gas compressor 2 for compressing low calorific value gas, such as landfill gas, for combustion in the combustion chamber of a gas turbine engine. The gas compressor 2 comprises a turbo-compressor, which can provide the necessary high compression ratio required to enable low calorific value gas, in particular low methane content landfill gas, to be combusted in the combustion chamber of the gas turbine engine. The gas compressor 2 is driven by a turbine 4, the turbine 4 being driven by the hot gases exiting the combustion chamber of the engine.

Gas is supplied to the gas compressor 2 through an inlet line 3 communicating with a source of low calorific value gas, such as landfill gas. A gas valve 5 is provided for controlling the flow of gas supplied to the gas compressor. An air supply line 6 branches off the inlet line 3 for mixing a non-combustible gas, such as air, into the gas supplied to the gas compressor 2, the air supply line 6 being connected to a source of non-combustible gas, such as a reservoir of pressurized air. Alternately, the non-combustible gas is supplied to the air supply line by a fan or air pump. An air valve 8 controls the flow rate of air into the compressor 2.

Low quality fuel gas is supplied through the gas valve 5, which enables the gas supply pressure to the gas compressor 2 to be set. Air is supplied through the air supply line 6 by a fan or other source or pressurized air. The air flow rate is adjusted by the air control valve 8 to determine the amount of air to be mixed with the gas.

To reduce the power output of the gas turbine engine, the air valve 8 is opened further, increasing the proportion of air in the mixture supplied to the gas compressor 2, so reducing the quantity of combustible fuel supplied to the combustion chamber. The air valve 8 is thus the means of controlling the power output and speed of the gas turbine engine.

By maintaining the total volume flow rate of gas and air supplied to the gas compressor 2, the gas compressor 2 always runs at its design point and potentially damaging fluctuations in the speed of the compressor are avoided.

Therefore the apparatus enables the power output of the gas turbine engine to be readily controlled by means of the air valve 8 to meet the required demand without requiring throttling of the gas supplied to the combustion chamber, enabling the use of a turbo-compressor to compress the fuel gas. Furthermore, by monitoring the power output of the engine, or by monitoring the speed of the gas turbine, a feedback control regime for the air valve can be provided to compensate for fluctuations in the methane content of the landfill gas. For example, when an increase in engine speed is detected, indicative of an increase in the calorific value (i.e. methane content) of the fuel gas, the air valve can be opened further to increase the flow rate of air into the gas compressor to effectively reduce the proportion of methane in the fuel gas supplied to the combustion chamber by diluting the methane with air.

The invention is not limited to the embodiment(s) described herein but can be amended or modified without departing from the scope of the present invention.

1. An apparatus for controlling the operation of a gas turbine engine to enable the engine to utilize low calorific value gas, such as low quality landfill gas, said apparatus comprising a gas compressor for compressing gas to be combusted in the combustion chamber of the engine, means for supplying a low calorific value gas to an input of said compressor, and means for mixing a non-combustible gas, such as air, with said low calorific-value gas supplied to the compressor to control the power output of the engine while maintaining a substantially constant flow rate of gas through the compressor.

2. An apparatus of claim 1, wherein said gas compressor comprises a turbo-compressor.

3. An apparatus of claim 1 further comprising control means for controlling the amount of non-combustible gas mixed with the low calorific value gas as a function of a desired power output of the engine.

4. An apparatus of claim 3, wherein said control means is arranged to control the amount of non-combustible gas mixed with the low calorific value gas as a function of a measured power output or speed of the engine in order to eliminate fluctuations in the power output of the engine caused by fluctuations in the calorific value of the low calorific value gas.

5. An apparatus of claim 1 further comprising means for controlling the flow rate of low calorific value gas in proportion of the flow rate of the non-combustible gas to maintain a constant total flow rate of the mixture of low calorific value gas and non-combustible gas supplied to the compressor.

6. An apparatus of claim 1, wherein the flow rate of non-combustible gas mixed with the low calorific value gas is controlled by a first valve.

7. An apparatus of claim 1, wherein the non-combustible gas is supplied from a pressurized source, such as a pressurized reservoir or from a pump or a fan or other source of pressurized air.

8. An apparatus of claim 1, wherein a second valve is provided for controlling the flow of low calorific gas supplied to the compressor.

9. An apparatus of claim 1, wherein the compressor is operably connected to a turbine for driving the compressor.

10. An apparatus of claim 9, wherein said turbine is arranged to be driven by the hot gases exiting the combustion chamber of the gas turbine engine.

11. An apparatus of claim 9, wherein said compressor may be operable connected to the output shaft of the gas turbine engine.

12. A method of controlling the operation of a gas turbine engine to enable the engine to utilize low calorific value gas, such as low quality landfill gas, said gas turbine engine comprising a compressor for compressing gas to be supplied to the combustion chamber of the engine, said method comprising mixing a non-combustible gas, such as air, with said low calorific-value gas supplied to the compressor to control the power output of the engine while maintaining a substantially constant flow rate of gas through the compressor.

13. A method of operating a gas turbine engine comprising providing a compressor for supplying high pressure gas to the combustion chamber of the gas turbine engine, supplying a mixture of a low calorific value gas and a non-combustible gas to the compressor and adjusting the proportion of non-combustible gas in said mixture to control the power output of the gas turbine engine.

14. A method of claim 13, wherein the compressor is a turbo-compressor.
